(19) United States
(12) Patent Application Publication
(10) Pub. No.: US 2009/0103966 A1
(43) Pub. Date: Apr. 23, 2009

(54) MEDIA ROLL POSITIONING ASSEMBLY AND METHOD FOR POSITIONING A MEDIA ROLL

(75) Inventor: Michael P. HOY, Vancouver (CA)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 12/254,934

(22) Filed: Oct. 21, 2008

Related U.S. Application Data
(60) Provisional application No. 60/960,956, filed on Oct. 22, 2007.

(51) Int. Cl. B41F 15/04

(52) U.S. Cl. 400/619

(57) ABSTRACT

A media roll positioning assembly for positioning a roll of media includes a guiding device, a retainer and a media roll supporting device. The media roll supporting device includes an elongated element for supporting the roll of media and a support configured to support the media roll supporting device on the guiding device. The guiding device is configured to movably support the support to guide the support in a main displacement direction from an input position to a reference position, the reference position being defined by a reference element. The retainer is configured to retain the support in the reference position, the support being removable from the reference position by application of a force on the media roll supporting device, the force exceeding a predetermined threshold force.

### CROSS-REFERENCE TO RELATED APPLICATIONS

This application claims priority under 35 U.S.C. § 119(e) to U.S. Provisional Application No. 60/960,956 filed on Oct. 22, 2007, the entirety of which is expressly incorporated herein by reference.

### BACKGROUND OF THE INVENTION

1. Field of the Invention

The present invention relates to a media roll positioning assembly and to a method for positioning a media roll in such assembly. In particular, the media roll positioning assembly is configured for use in a printing device.

2. Description of Background Art

In a printer device according to the background art, a print medium on which an image or text is printed may be supplied on a roll. Such a media roll is to be input in the printing device with a predetermined positional accuracy. The accuracy is not only required with respect to the actual position of the media roll, but with respect to its orientation as well. If the media roll is positioned askew with respect to a predetermined media path through the printer device, the media may get stuck in the printer device, for example.

A printer device according to the background art comprises a relatively flat surface on which a print medium is to be positioned. Such a printer may be used for printing on relatively inflexible and/or large media. To print on a medium like paper, for example, it is known to use a roll-to-roll assembly, which may be arranged such that the medium may be printed on while the medium is being transported from an input roll to an output roll. The roll-to-roll assembly may be an optional add-on device.

The roll-to-roll assembly according to the background art comprises an input assembly for supplying a roll of medium. An input assembly according to the background art comprises a locking device for retaining the media roll. When placing the media roll in the input assembly, the media roll needs to be correctly positioned and the locking device requires operation from an operator. Hence, considering that such a media roll is heavy and difficult to handle, introducing and positioning the media roll is difficult and/or requires a relatively large number of method steps.

Moreover, the input assembly according to the background art is originally configured to be used in combination with a printing press machine. Such a machine requires a heavy duty input assembly, usually provided with a pneumatically operated media retaining shaft. Such an input assembly is thus overkill for a media roll for use with a printing device of the above-described kind and is accordingly relatively expensive.

### SUMMARY OF THE INVENTION

It is an object of the present invention to provide a media roll positioning assembly and corresponding method that is user-friendly.

The object is achieved in a media roll positioning assembly for positioning a roll of media that comprises a guiding device, a retainer and a media roll supporting device and in a method for positioning a media roll in a printing device.

The media roll positioning assembly according to the present invention comprises a media roll supporting device, which comprises an elongated element for supporting the roll of media and a support configured to support the media roll supporting device on a guiding device. The media roll supporting device is configured such that a media roll may be positioned around the elongated element, when the media roll supporting device is not connected to or arranged in any other device or assembly. Hence, an operator or user may easily position the media roll around the elongated element. The support is configured and arranged such that the support may support the media roll arranged around the elongated element. In particular, the support is configured to support the media roll supporting device, including a media roll, on the guiding device.

The guiding device is arranged and configured to receive the media roll supporting device at an input position thereof. Then, the media roll supporting device may be moved from the input position to a reference position. The movement is guided by the guiding device such that the media roll supporting device has a predetermined position relative to the printing device when positioned at the reference position.

At the reference position, the media roll supporting device is retainable by the retainer. In particular, the retainer is configured to retain the support in the reference position and, hence, a media roll arranged around the elongated element may rotate without obstruction from the retainer. The media roll supporting device may be easily removed from the reference position by application of a force—in an embodiment substantially directed in the main displacement direction—which force should exceed a predetermined threshold force. Thus, the media roll is retained in the reference position, when the printing device is in operation and the medium is pulled from the media roll.

In an embodiment, the reference element comprises a reference surface, wherein the reference surface extends substantially perpendicular with respect to the main displacement direction. The reference surface is configured for engaging the support for, thereby, radially positioning the media roll supporting device. Similarly, the reference element may comprise a reference surface for engaging the support and extending substantially parallel to the main displacement direction for, thereby, axially positioning the media roll supporting device. It is noted that, in an embodiment, a single reference element may comprise multiple reference surfaces. Further, in an embodiment, multiple reference elements may each provide a reference surface, cooperating for accurately positioning the media roll supporting device in multiple directions.

In an embodiment, the guiding device comprises at least one guiding groove substantially extending in the main displacement direction and the support is configured to be received in said guiding groove such that the media roll supporting device is guidably movable in said main displacement direction by moving the support through said guiding groove. The guiding groove may guide the support not only in the main displacement direction, but also in a direction perpendicular to the main displacement direction. For example, in an embodiment, the guiding groove may comprise a tapered portion. In particular, a side wall of the guiding groove may be employed as a reference surface for positioning the support guided by the guiding device.

In an embodiment, the elongated element extends substantially perpendicular to the main displacement direction. In such embodiment, the side wall of the guiding groove may provide a reference surface for axially positioning the support and thereby axially positioning a media roll arranged around the elongated element.

In an embodiment, radial positioning may be performed by providing a reference surface at an end of the guiding groove. For example, a recess in a bottom wall of the guiding groove may be configured to at least partly receive the support. It is noted that in such an embodiment, the recess may be considered a retainer, while a wall of the recess may be considered a reference surface of a reference element.

In an embodiment, the retainer may comprise a lever. The lever may comprise a retaining element. The lever is configured to have a first position in which it is configured to engage with the support positioned in the reference position such that the support is retained in the reference position. Further, the lever is configured to have a second position in which it is configured not to retain the support positioned in the reference position. In particular, the lever is configured to move from the first position to the second position for releasing the support, when a force exceeding the predetermined threshold force is applied to the media roll supporting device.

In an embodiment, the lever is spring loaded for pressing the retaining element against the support, when positioned in the reference position, such that the support is pressed against the reference element.

In an embodiment, the support is rotatably connectable to the elongated element. Thus, the elongated element may rotate, while the support remain stationary, supported by the guiding device and retained by the retainer.

In an embodiment, the elongated element comprises a fixation device configured to fixate a media roll around the elongated element, and the fixation device is configured to co-axially position the media roll with respect to an axis of the elongated element. Thus, the media roll is fixed on the media roll supporting device. Consequently, when the media roll supporting device is arranged at the reference position, thereby having a predetermined position, the media roll is arranged in a predetermined position. Preferably, a ruler is provided on the elongated element such that the media roll may be positioned relative to the elongated element in an axial direction. Thereby, the media roll is also provided with a predetermined position in the axial direction, when the media roll supporting device is provided with a predetermined axial position, when arranged in the reference position.

In an embodiment, the support is a substantially circularly shaped element, which may roll over the guiding device. In particular, the substantially circularly shaped element is formed as a disc such that it may roll through a guiding groove.

In an aspect, the present invention further provides a printing device comprising the media roll positioning device according to any embodiment of the present invention.

In the method according to the present invention a media roll is positioned in a printing device. The media roll is arranged on a media roll supporting device. The supporting device comprises a support. The support is configured to be positioned at an input position on a guiding device. Then, the media roll supporting device is moved in a main displacement direction from the input position to a reference position as defined by a reference element. In the reference position, the media roll supporting device is retained by a retainer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of an embodiment of a printing device;

FIG. 2A is a first perspective view of an embodiment of a media roll positioning assembly according to the present invention for use with the printing device of FIG. 1;

FIG. 2B is a second perspective view of the embodiment of the media roll positioning assembly of FIG. 2A;

FIG. 3A is a perspective view of an embodiment of a media roll supporting device according to the present invention for use in the media roll positioning assembly of FIG. 2;

FIG. 3B is a perspective view of a part of the embodiment of the media roll supporting device of FIG. 3A;

FIG. 3C is a side view of the embodiment of the media roll supporting device of FIG. 3A;

FIG. 4A is a perspective view of an embodiment of a guiding device and an embodiment of a retainer for use in an assembly of FIG. 2; and

FIG. 4B is a perspective view of an embodiment of the media roll positioning device comprising the media roll supporting device of FIG. 3A and the guiding device and the retainer of FIG. 4A.

### DETAILED DESCRIPTION OF THE PREFERRED EMBODIMENTS

The present invention will now be described with reference to the accompanying drawings, wherein the same reference numerals have been used to identify the same or similar elements throughout the several views.

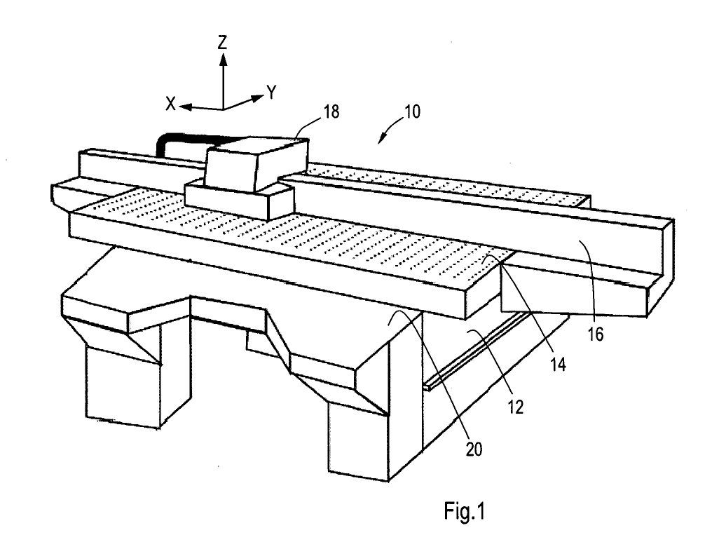

FIG. 1 shows a printing device 10 for printing an image or text on a relatively large object, in particular on a relatively large and flat object. Such a printing device 10 is well known in the background art. The printing device 10 comprises a support assembly 12 on which a printing surface 14 is arranged. As illustrated, the printing surface 14 may be provided with suction holes for pulling the object onto the printing surface 14 and thereby holding the object flat on the printing surface 14. A guiding assembly 16 is provided for supporting and guiding a carriage 18. The carriage 18 is movably supported by the guiding assembly 16 such that the carriage 18 may be moved over the printing surface 14. For example, the guiding assembly 16 may be movably supported on the support assembly 12 such that the guiding assembly may be moved in a y-direction (as indicated in FIG. 1) and the carriage 18 may be moveably supported by the guiding assembly 16 such that the carriage may be moved in a x-direction guided by the guiding assembly 16. The carriage 18 is provided with a printing element such as an inkjet printhead for printing the image or the text on the object arranged on the printing surface 14 by ejecting ink drops at predetermined positions. It is noted that the guiding assembly 16 and/or the carriage 18 may be supported such that they may be moved in a z-direction, thereby enabling printing on different media (i.e. objects) having a different dimension in the z-direction (when positioned on the printing surface 14).

The printing device 10 further comprises an interface assembly 20. The interface assembly 20 is configured for connecting a media roll supporting assembly to the printing device 10 such that the printing device 10 is enabled to print on a media that is supplied from a roll instead of a medium that is positioned on the printing surface 14, although it is noted that in an embodiment the medium that is supplied from a roll may be moveably supported by, guided over and positioned on the printing surface 14. In such an embodiment, the medium may be transported from a supply roll arranged at a first side of the printing surface 14 to a media receiving roll arranged at a second side of the printing surface 14. Hereinafter, an embodiment, which is illustrated in the drawings, is elucidated, in which embodiment a media supply roll and a media receiving roll are arranged at one side of the printing surface 14.

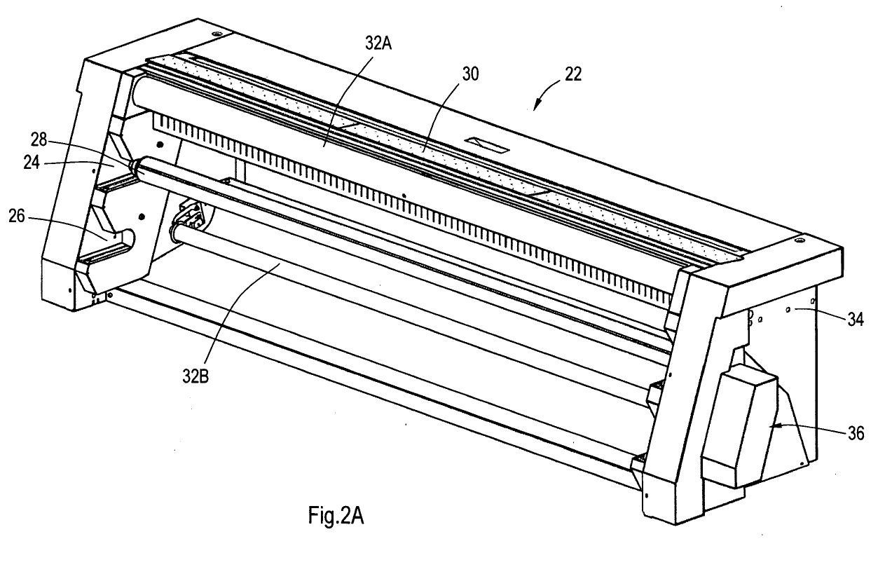

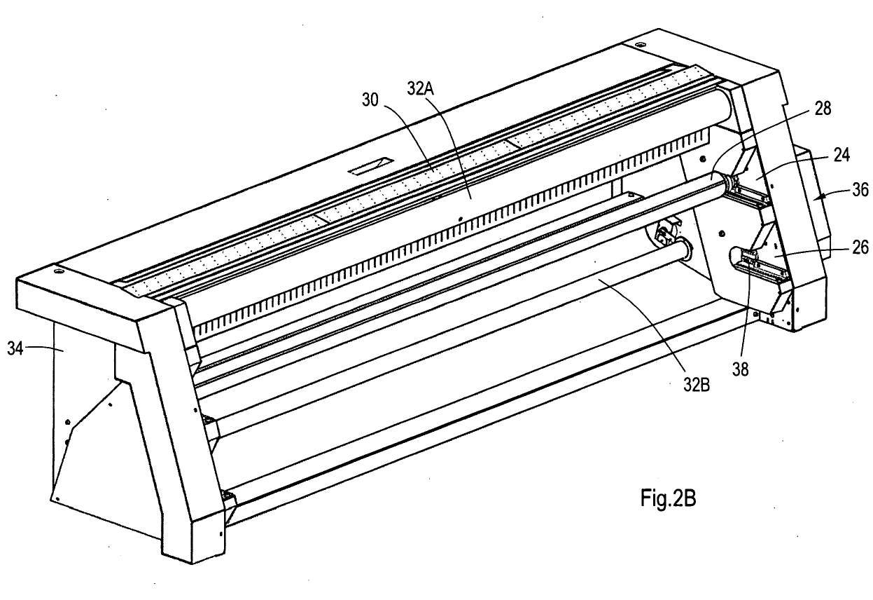

FIGS. 2A and 2B show a media roll supporting assembly 22 configured for being coupled to the printing device 10 of FIG. 1. The media roll supporting assembly 22 comprises a first media roll slot 24 and a second media roll slot 26 for supporting two media rolls. In particular, in the illustrated embodiment, a first media roll may supply a medium, while a second media roll may receive the medium after it has been printed. For supporting the media rolls, each slot 24, 26 is configured for receiving a media roll supporting device 28. The media roll supporting device 28 is configured to receive and support the media roll. The media roll supporting device 28 comprises an elongated element around which the media roll may be arranged. The elongated element may be a bar or axle having a cylindrical cross-section, for example. Also other suitable shapes may be employed. The media roll supporting device 28 further comprises a support and may her comprise an assembly of a number of parts, possibly providing additional functionality. In any case, the media roll supporting device 28 is removeably supported in at least one slot 24, 26. Preferably, the media roll supporting device 28 is supported in a suitable slot 24, 26 at each end of the media roll supporting device 28.

For printing, the medium supplied from a roll arranged in the media roll supporting assembly 22 is guided through the media roll supporting assembly 22 such that the media is moveably supported by and positioned on a media printing surface 30, possibly provided with a device for holding the medium substantially flat on the media printing surface 30. Such device may include, but is not limited to, a suction device. For guiding, one or more medium guiding rolls may be provided. For example, a first guiding roll 32A and a second guiding roll 32B may be provided.

One or both media rolls may be driven by a motor 36, for example through the media roll supporting device 28 supporting the media roll. In FIGS. 2A 2B, the motor 36 is arranged at one side of the media roll supporting assembly 22. Hence, each media roll supporting device 28 is driven at one end thereof. In an embodiment, the motor 36 may be provided at both ends of the media roll supporting device 28. As shown in FIG. 2B, a drive coupling 38 is provided for operatively coupling the motor 36 and the media roll supporting device 28.

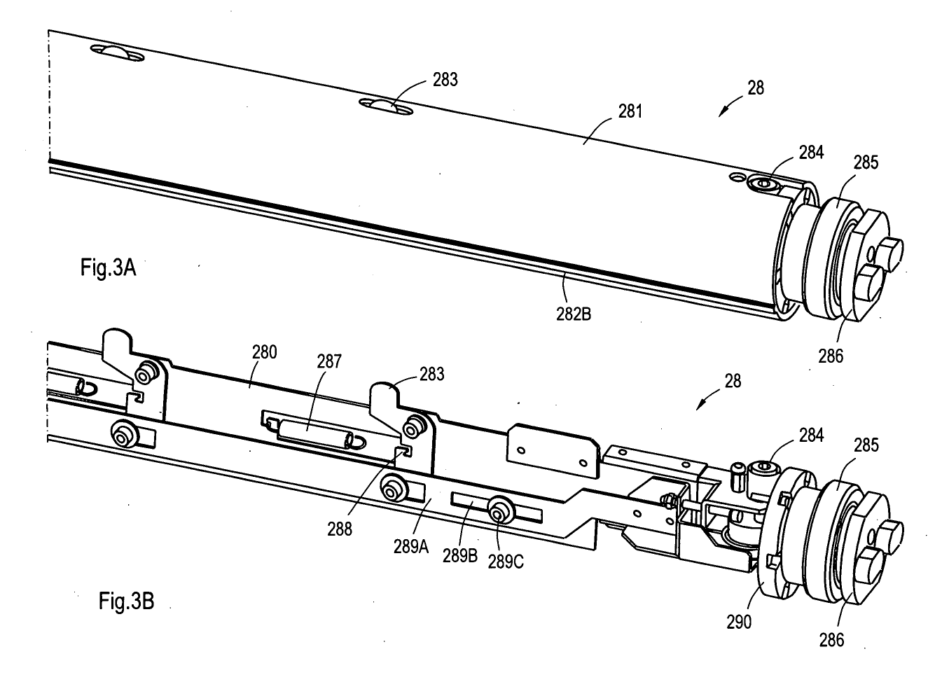

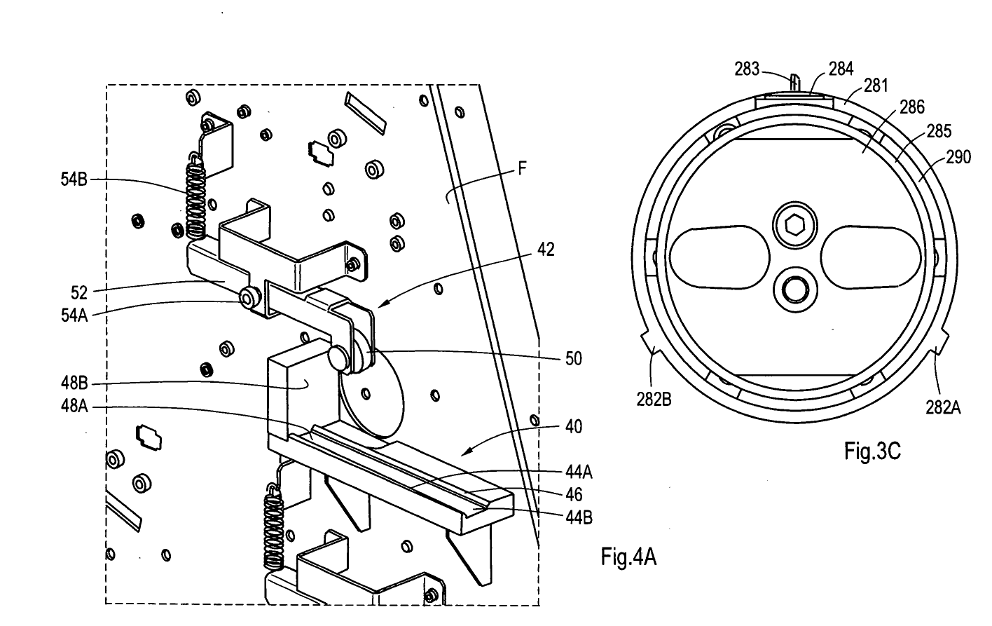

FIG. 3A shows an embodiment of a media roll supporting device 28 for use in the media roll positioning assembly 22 illustrated in FIGS. 2A-2B. FIGS. 3B and 3C show the embodiment of the media roll supporting device 28 in more detail. Now referring to FIGS. 3A-3C, the media roll supporting device 28 comprises a base frame element 280. A substantially cylindrical outer casing 281 surrounds the base frame element 280. A first positioning rib 282A and a second positioning rib 282B protrude from the outer casing 281. Further, a media roll locking pin 283 is also configured to protrude from the outer casing 281 in order to hold a media roll in a predetermined position relative to the media roll supporting device 28 by bringing the media roll in engagement with the first and second positioning ribs 282A, 282B.

The locking pin 283 is operatively coupled to a locking interface 284, enabling an operator to actuate the locking pin 283. As illustrated, the locking interface 284 may be a threaded pin or bolt, or the like, which may be coupled through a cam assembly to a locking mechanism. The locking mechanism may comprise an elongated coupling element 289A, provided with a guiding recess 289B which may slide over a guide pin or bolt 289C, for example. The elongated coupling element 289A may be operatively coupled to the locking pin 283. The locking pin 283 may be pre-tensioned by a tensioning mechanism such as a spring 287. For illustrative purpose, the spring 287 is shown disjointed from a coupling element 288 of the locking pin 283. However, in practice, the spring 287 can be hooked to the coupling element 288 for driving the locking pin 283 outward relative to the outer casing 281 and for thereby engaging a media roll. Thus, operating the locking interface 284 results in driving the locking pin 283 inward against the spring force. Consequently, since the media roll is engaged with a force corresponding the spring force, there will be virtually no influence of an operator on the force applied to the media roll.

The media roll supporting device 28 is further provided with a supporting device 285. In the illustrated embodiment, the supporting device 285 comprises a track roller, which may be received in and be guideably moveable in a main displacement direction through a guiding device. Such guiding device is comprised in the slots 24, 26 (FIGS. 2A, 2B). Further, the media roll supporting device 28 comprises an engaging device 286 for engaging the drive coupling 38 (FIG. 2B). In the illustrated embodiment, the drive coupling is achieved using a Oldham drive feature, which is well known in the background art.

In operation, when loading a media roll, the media roll supporting device 28 is removed from the media roll supporting assembly 22 (FIG. 2A, 2B). The locking pin 283 is driven inwardly by operating the locking interface 284. The media roll, usually having a substantially cylindrical cardboard core with a through hole, is arranged around the media roll supporting device 28 such that one or both ends of the media roll supporting device 28 protrudes from the media roll, thereby enabling the positioning of one or both ends in a corresponding slot 24, 26 of the media roll supporting assembly 22. In particular, the media roll may be axially centered with respect to the media roll supporting device 28.

Then, the operator again operates the locking interface 284. Thus, the locking pin 283 is driven outward due to the spring force applied to the locking pin 283 by the spring 287. If the media indeed comprises a cardboard core, it may be desirable to provide the locking pin 283 with a sharp edge or sharp tip, which is configured to be at least partially driven into the cardboard of the core, thereby fixing the cardboard core and media roll in an axial direction of the media roll supporting device 28. Further, the locking pin 283, by being driven outward, pushes the media roll core such that the core is brought into engagement with the first and the second positioning rib 282A, 282B. As a result, the media roll is provided with a predetermined position relative to the media roll supporting device 28. Once the media roll has obtained a substantially fixed position on the media roll supporting device 28, the media roll supporting device 28 may be replaced in the media roll supporting assembly 22. By ensuring that the media roll supporting device 28 is provided with a predetermined position relative to the media roll supporting assembly 22, the media roll thus obtains a predetermined position relative to the media roll supporting assembly 22.

Removing an empty core of a supply roll or removing a full receiving roll may be performed by a method similar to the above method, in which the media roll is removed from the media roll supporting device 28 instead of arranging the media roll around the media roll supporting device 28.

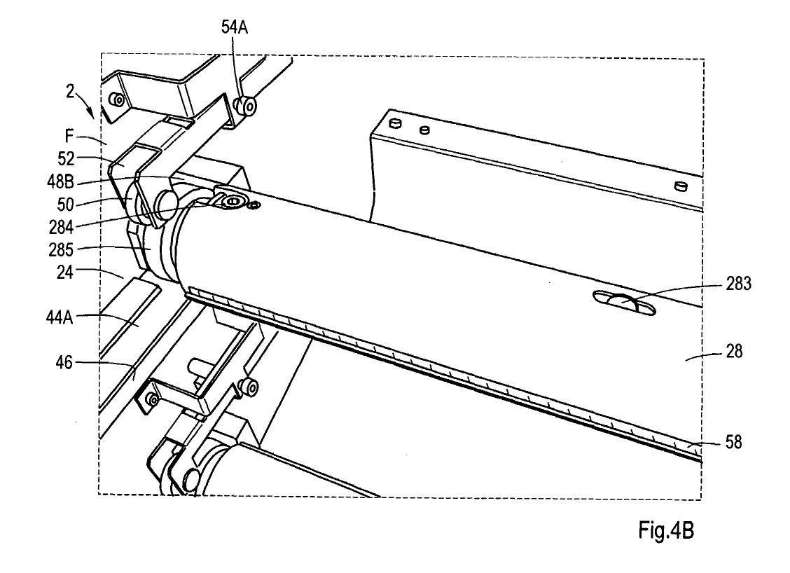

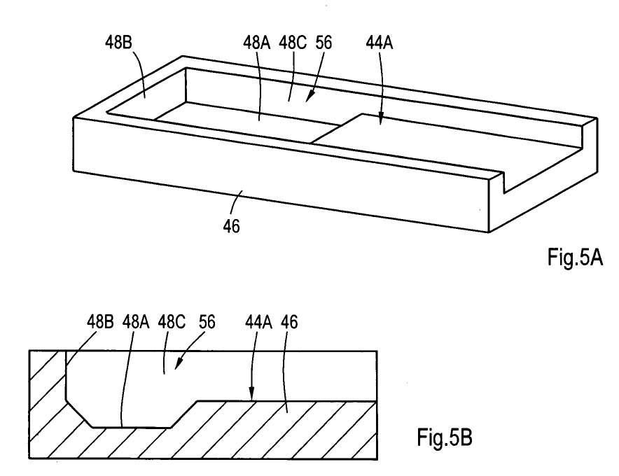

FIG. 4A shows an embodiment of guiding device 40 and retainer 42 according to the present invention. The guiding device 40 and the retainer 42 are provided on a frame element F. The frame element F is a part of a frame of the media roll supporting assembly 22. In the illustrated embodiment, the guiding device 40 comprises a guiding groove 44A arranged in a support element 46. The support element 46 is configured to support (a weight of) a media roll including the media roll supporting device 28. In an embodiment, the guiding groove 44a comprises a tapered portion 44B.

The guiding groove 44A substantially extends in a main displacement direction. At the point where the tapered portion 44B of the guiding groove 44A has a relatively large width, an operator may relatively easily position the support 285 in the guiding groove 44A. By moving the support 285 through the guiding groove 44A in the main displacement direction, in which direction the width of the guiding groove 44A becomes smaller, the media roll supporting device 28 obtains a predetermined axial position relative to the media roll supporting assembly 22. Thus, a vertically extending side wall of the guiding groove 44A may be considered to be a first reference surface 48A for axially positioning the media roll supporting device 28 and a media roll supported by said media roll supporting device 28.

At an end of the guiding groove 44A, a second reference surface 48B may be provided by a reference element extending substantially perpendicular with respect to the main displacement direction provided by the guiding groove 44A. Thus, the media roll may be loaded into the media roll supporting assembly 22 by moving the media roll supporting device 28 through the guiding groove 44A in the main displacement direction towards the second reference surface 48B and engaging the support 285 with said second reference surface 48B, thereby positioning the media roll supporting device 28 and the corresponding media roll in the main displacement direction.

The retainer 42 is configured to hold the media roll supporting device 28 in a predetermined reference position defined by the engagement of the support 285 of the media roll supporting device 28 with the first reference surface 48A and the second reference surface 48B. In the illustrated embodiment, the retainer 42 comprises a retaining element 50 coupled to a lever 52. The lever 52 is rotatably coupled to the frame F at a rotation point 54A. Further, a spring 54B is arranged between an end portion of the lever 52 and the frame F. Thus, the retaining element 50 is configured to enable positioning of the support 285 in the predetermined reference position, since the retaining element 50 is arranged such that the retaining element 50 may be moved, when the support 285 is moved towards the predetermined reference position. Further, due to the spring 54B, the retaining element 50 may be engaged with the support 285 such that the support 285 is engaged with the first and the second reference surfaces 48A, 48B.

FIGS. 5A and 5B show another embodiment of a support element 46 for use in the retainer 42. The illustrated support element 46 comprises a recess 56 at the predetermined reference position. The recess 56 may define the predetermined reference position, since a bottom wall of the recess 56 may provide the first reference surface 48A, a first side wall of the recess 56 may provide the second reference surface 48B and/or a second side wall of the recess 56 may provide a third reference surface 48C. As above described, for axially positioning the media roll supporting device 28, a side wall of the guiding groove 44A may be employed. In the embodiment illustrated in FIGS. 5A, 5B, said second side wall may be employed as the reference surface for axial positioning. It is noted that the recess 56 obviates the use of a retaining element 50 as illustrated in FIG. 4A. However, it is contemplated that both a recess 56 and the retaining element 50 are comprised in the retainer 42. Further, although not explicitly shown in FIGS. 5A, 5B, the guiding groove 44A comprising the recess 56 may be provided with a tapered portion 44B.

Now referring to FIG. 4B, the media roll supporting device 28 is shown, when positioned in the media roll supporting assembly 22. In FIG. 4B, the media roll supporting device 28 is provided with a ruler 58. The ruler 58 is provided for positioning a roll of media axially centered on the media roll supporting device 28.

In operation, the media roll supporting assembly 22 (FIGS. 2A-5B) is coupled to the printing device 10 (FIG. 1). The embodiment as illustrated in the drawings is such that the guiding assembly 16 may be positioned over the media roll supporting assembly 22, when the media roll supporting assembly 22 is coupled to the printing device 10 and the carriage 18 may move over the media printing surface 30 of the media roll supporting assembly 22. However, as described above, the medium provided on a roll may be guided over the printing surface 14 of the printing device 10. In such an embodiment, the guiding assembly 16 is not required to be enabled to be positioned over (a part of) the media roll support assembly.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as one or more than one. The term plurality, as used herein, is defined as two or more than two. The term another, as used herein, is defined as at least a second or more. The terms including and/or, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A media roll positioning assembly for positioning a roll of media, comprising:
a guiding device;
a retainer; and
a media roll supporting device, the media roll supporting device including:
an elongated element for supporting the roll of media; and
a support configured to support the media roll supporting device on the guiding device,
wherein the guiding device is configured to movably support the support to guide the support in a main displacement direction from an input position to a reference position, the reference position being defined by a reference element, and
wherein the retainer is configured to retain the support in the reference position, the support being removable from the reference position by application of a force on the media roll supporting device, said force exceeding a predetermined threshold force.

2. The assembly according to claim 1, wherein the reference element further comprises a reference surface, the reference surface extending substantially perpendicular with respect to the main displacement direction, and wherein the reference surface is configured for engaging the support to radially position the media roll supporting device.

3. The assembly according to claim 1, wherein the reference element further comprises a reference surface, the reference surface extending substantially parallel to the main displacement direction, and wherein the reference surface is configured for engaging the support to axially position the media roll supporting device.

4. The assembly according to claim 1, wherein the guiding device further comprises at least one guiding groove substantially extending in the main displacement direction, and wherein the support is configured to be received in said guiding groove such that the media roll supporting device is guidably movable in said main displacement direction.

5. The assembly according to claim 4, wherein the guiding groove comprises a tapered portion.

6. The assembly according to claim 4, wherein a side wall of the guiding groove forms a reference surface engageable with the support for positioning the media roll supporting device.

7. The assembly according to claim 1, wherein the retainer further comprises a recess, the recess being provided in the guiding device and being configured to receive the support.

8. The assembly according to claim 7, wherein a wall of the recess forms a reference surface engageable with the support for positioning the media roll supporting device.

9. The assembly according to claim 1, wherein the retainer further comprises a lever, the lever comprising a retaining element, the retaining element being configured to engage with the support, when positioned in the reference position, to retain the support in said reference position.

10. The assembly according to claim 9, wherein the lever is spring loaded for pressing the retaining element against the support, when positioned in the reference position, such that the support is pressed against the reference element.

11. The assembly according to claim 1, wherein the support is rotatably connectable to the elongated element.

12. The assembly according to claim 11, wherein the elongated element further comprises a fixation device configured to fixate a media roll around the elongated element, and wherein the fixation device is configured to co-axially position the media roll with respect to an axis of the elongated element.

13. The assembly according to claim 12, wherein a ruler is provided on the elongated element such that the media roll is positionable relative to the elongated element in an axial direction.

14. The assembly according to claim 1, wherein the support is substantially circularly shaped such that said support is rollable over the guiding device.

15. A printing device comprising:
a media roll positioning assembly for positioning a roll of media, the media roll positioning assembly comprising:
a guiding device;
a retainer; and
a media roll supporting device, the media roll supporting device including:
an elongated element for supporting the roll of media; and
a support configured to support the media roll supporting device on the guiding device,
wherein the guiding device is configured to movably support the support to guide the support in a main displacement direction from an input position to a reference position, the reference position being defined by a reference element, and
wherein the retainer is configured to retain the support in the reference position, the support being removable from the reference position by application of a force on the media roll supporting device, said force exceeding a predetermined threshold force.

16. A method for positioning a media roll in a printing device, the method comprising the steps of:
positioning the media roll on a media roll supporting device, the media roll supporting device comprising a support;
positioning the support of the supporting device, including the media roll, in an input position on a guiding device; and
moving the supporting device, including the media roll, in a main displacement direction from the input position to a reference position.
